(19) United States
(12) Patent Application Publication
(10) Pub. No.: US 2025/0206114 A1
(43) Pub. Date: Jun. 26, 2025

(54) SOLAR PICKUP TRUCK BED COVER WITH LOCK BOLT STRUCTURE

(71) Applicant: Yunxia SHAO, HANGZHOU (CN)

(72) Inventors: Shaoyong ZHENG, HANGZHOU (CN); Yunxia SHAO, HANGZHOU (CN)

(21) Appl. No.: 18/969,080

(22) Filed: Dec. 4, 2024

(30) Foreign Application Priority Data
Dec. 21, 2023 (CN) 202323525851.1

(51) Int. Cl. B60J 7/19

(52) U.S. Cl. CPC B60J 7/198

(57) ABSTRACT

The invention discloses a locking bolt fixing structure, which comprises a locking bolt fixing block and an insertion block. The locking bolt fixing block is provided with an insertion groove; there are two insertion grooves. The insertion block is designed to fit the insertion grooves and is used to restrict the locking bolt. The invention also discloses a car cover with a locking bolt fixing structure, which comprises a front bar, a locking bolt fixing structure, a rear bar, a side rail, a clamp assembly, and leather. The front bar, side rail, and rear bar together form the car cover frame. The car cover frame is connected to the car body via the clamp assembly, and the leather is attached to the car cover frame.

### CROSS-REFERENCES TO RELATED APPLICATIONS

The present disclosure claims the priority of Chinese Patent Application No. 202323525851.1, filed on Dec. 21, 2023, the entireties of which are herein incorporated by reference.

### FIELD

The invention is relevant to automobile accessories field, especially about a lock bolt fixing structure.

### BACKGROUND

Pickup trucks are one of the common automobiles in life. Due to the advantages of comfort, stability and ability to transport goods, pickup trucks are an integral part of the automobile market. The rear cargo hopper, as the most significant feature of pickup trucks, is often used for transportation of goods.

Most of the existing pickup trucks have an open structure, which can't protect the cargo in rainy or snowy days. Therefore, many pickup trucks began to be equipped with a separate cover, when using the car cover, the front part is not often open, while the rear part needs to be opened frequently, which requires the front and rear cover has a different locking structure, as the rear locking structure needs to be switched on and off frequently, it is relatively easy to be damaged, the rear locking structure should be not only convenient to open/close, but also reduce the replacement cost as much as possible.

The existing lock bolt fixing structure is mainly a one-piece structure, which needs to be replaced as a whole when it is damaged, which not only causes a high replacement cost, but also causes a waste of resources. In addition, since the car cover is all equipped later on, the existing car cover connecting structure is relatively single, which cannot be adapted to different models and has a narrow scope of application.

### SUMMARY

The purpose of the invention is to provide a solar pickup truck bed cover with lock bolt structure, by improving the structure, the light energy is converted into electrical energy for use by the customer, and also makes the opening and closing of the bed cover more convenient.

To solve the existing technical problem above, thus the invention uses the following method:

A lock bolt fixing structure comprises a lock bolt fixing block and an insertion block.

The lock bolt fixing block is provided with an insertion groove; there are two insertion grooves.

The insertion block is detachably connected with the insertion groove, the insertion block is used for restricting the lock bolt.

Further, the insertion block is provided with a convex end, the convex end is used for fitting with the insertion groove, there are two convex ends, the two convex ends are provided in correspondence with the two insertion grooves.

Further, the lock bolt fixing block is provided with a bottom support plate, the bottom support plate is located on the lower side of the insertion groove, one side of the insertion block is provided with an extension surface, the other side of the insertion block is provided with a beveled surface, the bottom support plate is provided on the lock bolt fixing block, the bottom support plate is located on the lower part of the insertion block, the bottom support plate is used to support the insertion block.

Further, the lock bolt fixing block is provided with a fixing groove, the insertion block is provided with a fixing bar groove, both the fixing groove and the fixing bar groove are used to clamp into place with the side rails, the lock bolt fixing block is provided with a positioning hole, the screws connect the lock bolt fixing block to the side rails through the positioning hole.

A car cover with a lock bolt fixing structure comprises a front bar, a lock bolt fixing structure, a rear bar, a side rail, a clamp assembly and a leather.

The front bar, the side bar and the rear bar forming a car cover frame, the car cover frame is connected to the car body through a clamp assembly, the leather is covered over the car cover frame.

The leather covers over the car cover frame in a whole, with one end of the leather connected to the front bar and the other end of the leather connected to the rear bar. When the car cover needs to be opened, it is only necessary to remove the rear bar from the side rails, and at the same time the leather is also separated from the side rails to realize the opening of the car cover. The width of the leather mentioned should be able to completely cover both side rails, so as to provide a good waterproof effect.

The lock bolt fixing structure is connected to the side rails, the rear bar is connected with a rear bar joint, the rear bar joint is connected with a rear bar lock bolt, the rear bar lock bolt is adapted to the lock bolt fixing structure.

Further, there are two rear bar joints, each of which is connected to a rear bar lock bolt, each of which is provided with a reset spring correspondingly, the two rear bar lock bolts are connected to each other by a steel wire rope, the length of the extension surface is less than or equal to the length of the rear bar lock bolt extending into the insertion block, there is a gap between the extension surface and the bottom support plate.

Further, the side rails comprises a first side rail, the first side rail is provided with a first side rail clamp groove, the clamp assembly comprises a first clamp assembly, the first clamp assembly comprises an upper clamp and a lower clamp, the upper clamp is provided with a tab, the tab is engaged with the first side rail clamp groove, the lower clamp is used to engage the car body, the upper clamp and the lower clamp are connected to each other by screws, the upper clamp is provided with a mounting groove, one end of the lower clamp extends into the mounting groove, the upper clamp is rotationally connected with the screw, and by rotating the screw, the lower clamp is made to move upwardly until it is clamped to the car body. The screw is rotationally connected with the upper clamp and the screw is threadedly connected with the lower clamp.

Further, the side rail comprises a second side rail, the second side rail is provided with a second side rail groove, the clamp assembly comprises a second clamp assembly, the second clamp assembly comprises a left clamp and a right clamp, the left clamp and the right clamp are bolted to each other, the left clamp is provided with a clamping portion, the right clamp is provided with an insertion portion, the insertion portion extends into the second side rail groove, the clamping portion and insertion portion clamps the car body and the second The left clamp and the right clamp is also connected with a T-screw.

The beneficial effects of this invention are:

1. The invention changes the original one-piece structure to a split structure by changing the lock bolt fixing structure, by adopting the combination of the lock bolt fixing block and the replaceable insertion block, the parts that are often in contact with the lock bolt are changed to replaceable parts, in case of the damage of the replaceable insertion block, the replaceable insertion block can be replaced individually to save the replacement cost.

By adopting different clamp assemblies, the invention is able to adopt different connection structures for different cargo hopper, making the cover more widely applicable.

2. The invention makes the cover more widely applicable by adopting different clamp assemblies and different connection structures for different cargo hoppers.

### BRIEF DESCRIPTION OF THE DRAWINGS

FIG. 1 is a structural schematic diagram of the lock bolt fixing structure in the invention.

FIG. 2 is a schematic diagram of the lock bolt fixing block in the invention.

FIG. 3 is a schematic diagram I of the insertion block in the invention.

FIG. 4 is a schematic diagram ii of the insert block in the invention.

FIG. 5 is a schematic diagram of the cooperation between the insertion block and the lock bolt.

FIG. 6 is a structural schematic diagram I of the car cover in the invention.

FIG. 7 is a partially enlarged view of part A in FIG. 6.

FIG. 8 is a structural schematic diagram II of the car cover in the invention.

FIG. 9 is a connection schematic diagram of the second clamp assembly in the invention.

FIG. 10 is a connection schematic diagram of the first clamp assembly in the invention.

FIG. 11 is a partially enlarged view of part B in FIG. 10.

In the figure: 1—Lock bolt fixing block; 101—Fixing groove; 102—Bottom support plate; 103—Insertion groove; 104—Positioning hole; 2—Insertion block; 201—Protruding end; 202—Extended surface; 203—Fixing bar groove; 204—Beveled surface; 3—Rear bar joint; 301—Rear bar lock bolt; 4—First clamp assembly; 401—Lower clamp; 402—Upper clamp; 4021—Tab; 403—screw; 5—First side rail; 501—First side rail clamp groove; 6—Rear bar; 7—Car body; 8—Second side rail; 801—Second side rail groove; 9—Second clamp assembly; 901—Left clamp; 9011—Clamping portion; 902—Right clamp; 9021—Insertion portion.

### DETAILED DESCRIPTION OF THE DISCLOSURE

The following instruction further explains the invention's concrete implementation method.

In order to enable a clearer understanding of the above-mentioned objects, features and advantages of the present invention, the present invention will be described in detail below in connection with the accompanying drawings and specific embodiments. It should be noted that the embodiments of the present application and the features in the embodiments can be combined with each other without conflict.

The terms “first,” “second,” “third,” etc. are only used to differentiate the description and should not be understood as indicating or implying relative importance.

In the description, it should also be noted that, unless otherwise expressly specified and limited, the terms “arranged,” “installed,” “connected,” and “combined” should be understood in a broad sense; for example, it may be a fixing connection, it can also be a detachable connection or an integral connection; it can be a mechanical connection or an electrical connection; it can be a direct connection or an indirect connection through an intermediate media, and it can be internal connection within two components. For those of ordinary skill in this field, the meanings of the above terms in the present invention can be understood in specific situations.

The specific embodiments of the present invention will be described in detail below in connection with the accompanying drawings. It should be understood that the specific embodiments described herein are intended only to illustrate and explain the present invention and are not intended to limit it.

### Embodiment 1

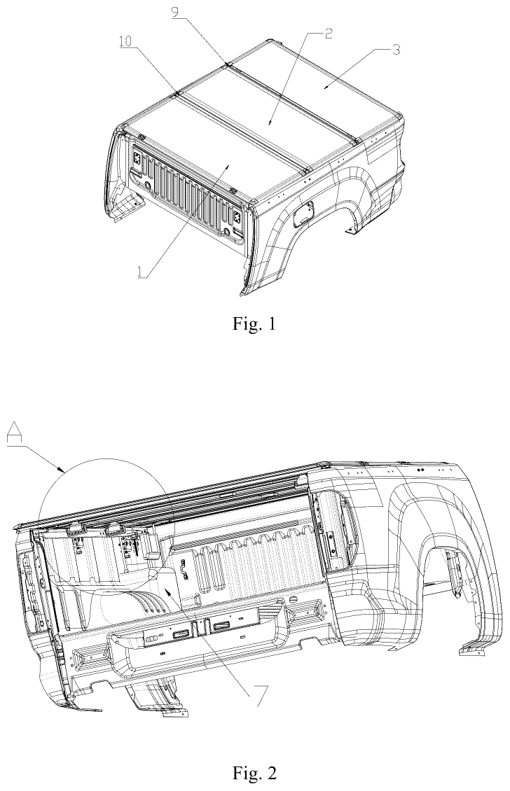

As shown in FIG. 1, a lock bolt fixing structure comprises a lock bolt fixing block 1 and an insertion block 2.

The lock bolt fixing block 1 is provided with an insertion groove 103, there are two insertion grooves 103.

The insertion block 2 is adapted to match the insertion groove 103, the insertion block is used for restricting the lock bolt.

The insertion block 2 is provided with a convex end 201, the convex end 201 is used for mating with the insertion groove 103. There are two convex ends 201, the two convex ends 201 are provided in correspondence with two insertion grooves 103.

When used, the use of the block 2 to limit the lock tongue, long time after the use of the block 2 is prone to deformation or damage, the insertion block 2 can be replaced solely, while retaining the lock bolt fixing block 1, to reduce the cost of replacement.

As most of the existing lock bolt fixing structure is made of plastic, it is prone to deformation or damage over time, once the damage occurs, it is required to replace the lock bolt fixing structure as a whole, thus resulting in a waste of cost. A split structure design makes the most easily damaged part replaceable, which can be replaced only partially without replacing the lock bolt fixing structure as a whole, thus greatly saving the replacement cost.

### Embodiment 2

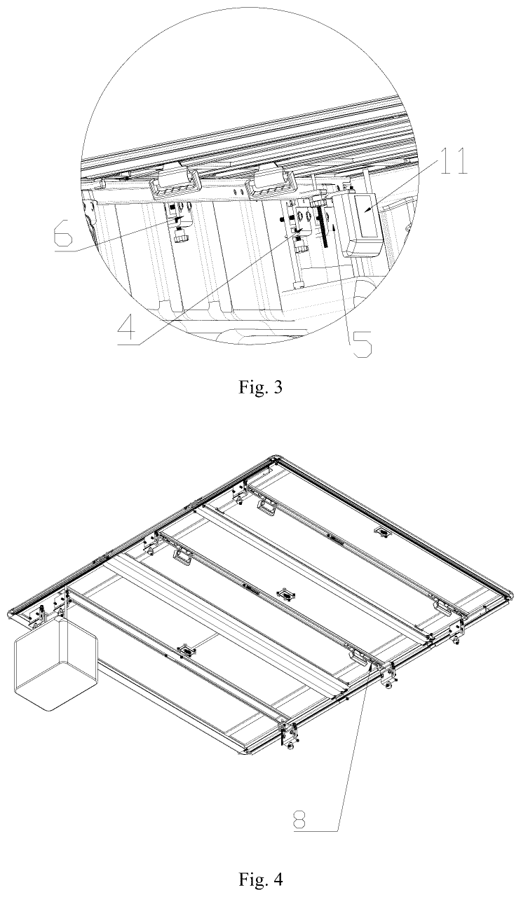

On the basis of embodiment 1, as shown in FIGS. 2-4, the lock bolt fixing block 1 is provided with a bottom support plate 102, the bottom support plate 102 is located on the lower side of the insertion groove 103;

One side of the insertion block 2 is provided with an extension surface 202, the other side of the insertion block 2 is provided with a beveled surface 204.

The bottom support plate 102 is provided on the lock bolt fixing block 1, the bottom support plate 102 is located on the lower part of the insertion block 2, the bottom support plate 102 is used to support the insertion block 2. When the insertion block 2 is inserted into the insertion groove 103, the convex ends 201 at both ends of the insertion block 2 are supported by the insertion groove 103, while the bottom of the insertion block 2 is supported by the bottom support plate 102 to enhance the force strength of the insertion block 2, which makes it possible to maintain a certain gap between the end of the extension surface 202 and the bottom support plate 102 during actual installation, with the beveled surface 204 located on the top side and the extension surface 202 located on the bottom side at this time.

In actual use, the upper side of the insert block 2 is designed as a beveled surface 204, when the lock bolt touches the beveled surface 204, it shrinks under the action of the beveled surface 204, and can easily pass over the insertion block 2, after the lock bolt passes over the insertion block 2, the lock bolt is then popped out, and the extension surface 202 restricts the lock bolt at this time to prevent the lock bolt from slipping out.

The lock bolt fixing block 1 is provided with a fixing groove 101, the insertion block 2 is provided with a fixing bar groove 203, both the fixing groove 101 and the fixing bar groove 203 are used to clamp into place with the side rails.

The lock bolt fixing block 1 is provided with a positioning hole 104, through which a screw connects the lock bolt fixing block 1 to the side rail. The screw connection avoids the movement of the lock bolt fixing block 1, the clamping of the fixing groove 101 with the side rail prevents the rotation of the lock bolt fixing block 1.

### Embodiment 3

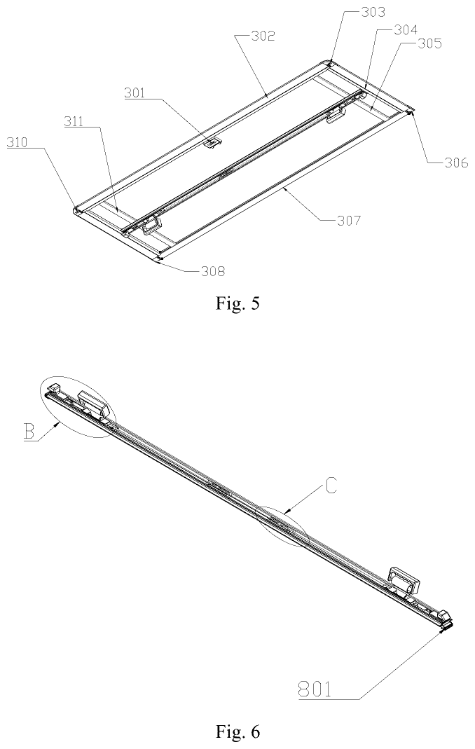

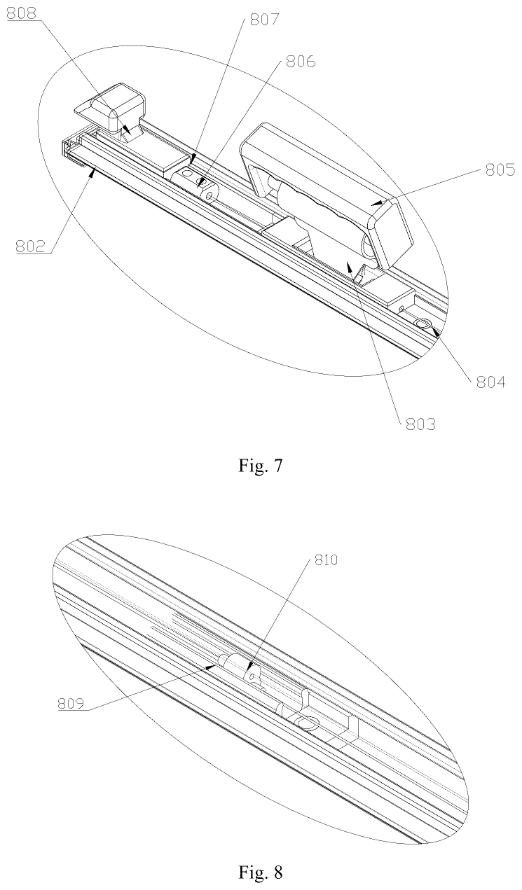

On the basis of claim 1 or 2, as shown in FIGS. 5-8, a car cover with a lock bolt fixing structure comprising a front bar, a lock bolt fixing structure, a rear bar 6, a side rail, a clamp assembly and a leather;

The front bar, the side rail and the rear rail 6 forming a car cover frame, the car cover frame is connected to the car body 7 through the clamp assembly, the leather is covered over the car cover frame.

The leather is covered on the car cover frame as a whole, mainly playing the role of rainproof and dustproof, in order to facilitate the opening of the car cover, one end of the leather is connected to the front bar (here, the leather can also be connected directly to the car body, as long as it can ensure its connection is stable and well-sealed, without leakage of water), and the other end of the leather is connected to the rear bar, when the rear bar is connected to the side bar, the leather covers the whole car cover frame, providing a good rainproof and dustproof effect.

When the rear bar is separated from the side rails, the skin is also separated from the side rails, so as to facilitate the opening of the car cover.

The rear bar is connected with a rear bar joint 3, said rear bar joint 3 is connected with a rear bar locking bolt 301, the rear bar locking bolt 301 is adapted to the lock bolt fixing structure.

Since the car cover needs to be opened frequently, it should be designed as a structure that is easy to open, and through the setting of the lock bolt fixing structure, the present application utilizes the lock bolt fixing structure to clamp with the rear bar lock bolt 301, so as to realize the locking of the car cover.

The opening of the car cover is realized by pulling the wire rope, a structure for opening the whole car cover is only provided in the rear bar, as long as the rear bar is opened it is possible to wind up the whole leather and realize the opening of the car cover.

The rear rail joint 3 further includes a reset spring, when pulling the wire rope, the wire rope drives the rear rail lock bolt 301 to contract, realizing the opening of the leather, at this time, the rear part of the leather is detached from the lock bolt fixing structure, and the reset spring drives the rear rail lock bolt 301 to reset after loosening the wire rope. Reset spring is a piece of existing technology, many locking structures are now equipped with reset springs.

When the cover needs to be closed tightly, the rear bar is pressed downward, the rear bar lock bolt 301 starts to contract after touching the beveled surface 204 of the insertion block 2, as long as the whole rear bar lock bolt 301 passes through the beveled surface 204, and extends out and resets under the elastic force of the reset spring, the rear bar is connected with the side rail at this time to form the frame of the cover into an integral whole.

There are two rear bar joints 3, each rear bar joint 3 is connected with a rear bar lock bolt 301, the two rear bar lock bolts 301 are connected to each other by a steel wire rope, the length of the extension surface 202 is not more than the length of the rear bar lock bolt 301, by setting two rear bar joints 3, both ends of the rear bar need to be locked at the same time when locking, when opening, the two rear bar lock bolts 301 can be opened at the same time as long as the steel wire rope is pulled.

### Embodiment 4

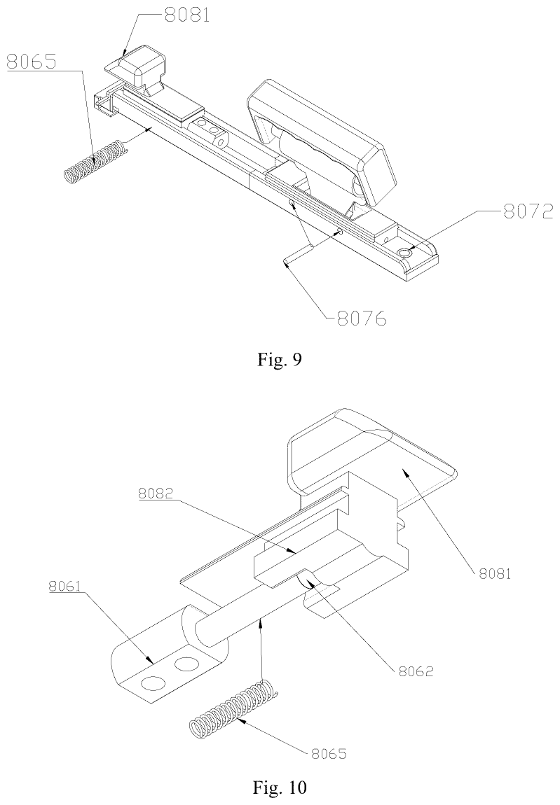

On the basis of embodiment 3, as shown in FIG. 9, the side rails comprise a first side rail 5, the first side rail 5 is provided with a first side rail clamp groove 501, the clamp assembly comprises a first clamp assembly 4, the first clamp assembly 4 comprises an upper clamp 402 and a lower clamp 401, the upper clamp 402 is provided with a tab 4021, the tab 4021 is clamped with the first side rail clamp groove 501,

The lower clamp 401 is used to engage the car body 7, the upper clamp 402 and the lower clamp 401 are connected to each other by screws 403.

The upper clamp 402 is provided with a mounting groove, one end of said the lower clamp 401 extends into the mounting groove, the upper clamp 402 is rotationally connected to the screw 403, by rotating the screw 403, the lower clamp 401 is made to move upwardly until it is clamped to the car body 7. The screw 403 is rotationally connected with the upper clamp 402, and the screw 403 is threadedly connected with the lower clamp 401.

In practice, there are two ways of clamping, one is that the top end of the lower clamp 401 clamps against the concave portion of the car body 7, the other is that the concave portion of the lower clamp 401 clamps against the convex portion of the car body 7.

During installation, the first clamp assembly 4 is utilized to clamp the first side rail 5 to the cargo hopper of the car body 7, so as to realize the connection between the cover frame and the car body 7.

### Embodiment 5

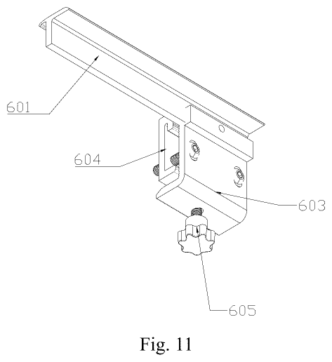

On the basis of embodiment 3, as shown in FIGS. 10 and 11, the side rails comprise a second side rail 8, the second side rail 8 is provided with a second side rail groove 801, the clamp assembly comprises a second clamp assembly 9, the second clamp assembly 9 comprises a left clamp 901 and a right clamp 902, the left clamp 901 and the right clamp 902 are bolted to each other, the left clamp 901 is provided with a clamping portion 9011, the right clamp 902 is provided with an insertion portion 9021, the insertion portion 9021 extends into the second side rail groove 801, the clamping portion 9011 and the insertion portion 9021 clamping the car body 7 and the second side rail 8.

The left clamp 901 and right clamp 902 are further connected to a T-screw.

When used, the insertion portion 9021 of the right clamp 902 is first extended into the second side rail groove 801, then the second side rail groove 801 is clamped against the car body 7, followed by placing the left clamp 901 on the exterior of the car body 7, at which time both the car body 7 and the second side rail 8 are placed between the left clamp 901 and the right clamp 902, and finally, spinning the screws 403 to tighten the left clamp 901 and the right clamp 902 and complete the process of connecting the car body 7 and the second side rail 8. On this basis, a T-screw can also be connected to realize the longitudinal tensioning of the left clamp 901 and the right clamp 902. By selecting different side rails and clamp assemblies according to different vehicles, the cover can be adapted to different vehicles.

### Specific Working Principle:

During installation, the front bar and side rails are first connected to the car body 7, the front bar is stably connected to the side rails and the car body 7 through a clamp assembly. Then, the lock bolt fixing structure is installed on the side rail, the lock bolt fixing block 1 is secured to the side rail using screws. Finally, the rear bar joint 3 is connected to the rear bar 6, and achieve the sealing of the car cover by the clamping of the rear bar lock bolt 301 and the lock bolt fixing block 1 of the rear bar joint 3, when the car cover needs to be opened, simply pull the steel wire rope, the rear bar lock bolt 301 retracts and disengages from the limit of the insert block, allowing the separation of the rear bar 6 from the side rail. Finally, the leather can be rolled up to open the car cover

The present invention is not limited to the above-mentioned optional embodiments, anyone can draw other various forms of products under the inspiration of the present invention. However, no matter what changes are made in its shape or structure, all technical solutions that fall within the scope defined by the claims of the present invention should fall within the protection scope of the present invention.

What is claimed is:

1. A lock bolt fixing structure comprising a lock bolt fixing block and an insertion block; wherein
the lock bolt fixing block is provided with an insertion groove;
the insertion block is detachably connected with the insertion groove, the insertion block is used for restricting the lock bolt.

2. The lock bolt fixing structure according to claim 1, wherein the insertion block is provided with a convex end, the convex end is used for fitting with the insertion groove.

3. The lock bolt fixing structure according to claim 1, wherein the lock bolt fixing block is provided with a bottom support plate, the bottom support plate is located on the lower side of the insertion groove; and
one side of the insertion block is provided with an extension surface, the other side of the insertion block is provided with a beveled surface.

4. A car cover comprising:
a lock bolt fixing structure comprising a lock bolt fixing block and an insertion block; wherein the lock bolt fixing block is provided with an insertion groove, the insertion block is detachably connected with the insertion groove, and the insertion block is used for restricting the lock bolt;
a front bar,
a lock bolt fixing structure,
a rear bar,
a side rail, and
a clamp assembly and a leather,
wherein the front bar, the side rail and the rear bar form a car cover frame, the rear bar is connected to the side rail through a rear bar joint, the car cover frame is connected to a car body through the clamp assembly, the leather is connected to the car cover frame; and
the lock bolt fixing structure is connected to the side rails, the rear bar is connected with a rear bar joint, the rear bar joint is connected with a rear bar lock bolt, the rear bar lock bolt is adapted to the lock bolt fixing structure.

5. The car cover according to claim 4, wherein there are two rear bar joints, each of which is connected with a rear bar lock bolt, the two rear bar lock bolts are connected with each other by a steel wire rope.

6. The car cover according to claim 5, wherein a length of an extension surface is less than or equal to a length of the rear bar lock bolt insertion block, there is a gap between the extension surface and the bottom support plate.

7. The car cover according to claim 4, wherein the side rail comprises a first side rail, the first side rail is provided with a first side rail snap-in groove; and
the clamp assembly comprises a first clamp assembly, the first clamp assembly comprises an upper clamp and a lower clamp, the upper clamp is provided with a tab, the tab is engaged with the first side rail snap-in groove, the lower clamp is for engaging with the car body, the upper clamp and the lower clamp are connected to each other by screws.

8. The car cover according to claim 7, wherein the upper clamp is provided with a mounting groove, one end of the lower clamp extends into the mounting groove, the screw is rotationally connected with the upper clamp, while the screw is threadedly connected with the lower clamp.

9. The car cover according to claim 4, wherein the side rail comprises a second side rail, the second side rail is provided with a second side rail groove; and
the clamp assembly comprises a second clamp assembly, the second clamp assembly comprises a left clamp and a right clamp, the left clamp and the right clamp are bolted to each other.

10. The car cover structure according to claim 9, wherein the left clamp is provided with a clamping portion, the right clamp is provided with an insertion portion, the insertion portion extends into the second side rail groove, the clamping portion and the insertion portion are provided to clamp the car body and the second side rail.
